(19) United States
(12) Patent Application Publication
(10) Pub. No.: US 2026/0298257 A1
(43) Pub. Date: Oct. 1, 2026

(54) TURBINE WHEEL FOR A RADIAL TURBINE

(71) Applicant: DAIMLER TRUCK AG, Leinfelden-Echterdingen (DE)

(72) Inventors: Jonah GERST, Stuttgart (DE); Oliver MEISTER, Uhingen (DE); Stephan NETZHAMMER, Waiblingen (DE); Michael ROTT, Fellbach (DE); Markus SCHNEID, Ludwigsburg (DE); Clemens SCHRÖDER, Weil im Schönbuch (DE)

(21) Appl. No.: 19/476,005

(22) PCT Filed: Feb. 28, 2024
(86) PCT No.: PCT/EP2024/055090

§ 371 Date: Oct. 16, 2025

(30) Foreign Application Priority Data
Apr. 17, 2023 (DE) 10 2023 109 634.6

(51) Int. Cl. F04D 29/28; F04D 17/10

(52) U.S. Cl. CPC F04D 29/284; F04D 17/10

(57) ABSTRACT

A turbine wheel for a radial turbine includes a hub with a turbine disc connected thereto and a plurality of turbine blades that are connected to the hub via a blade foot. The turbine blades each have a curvature following a line of curvature. Each turbine blade, when viewed from an orthogonal cut through the turbine blade, has a distribution of a thickness depending on a height of the turbine blade above the hub. The thickness of the turbine blade is greater at small heights than in a trapezoidal shape, in which the thickness decreases uniformly starting from the blade foot. The thickness of the turbine blade is smaller at large heights of the turbine blade than in the trapezoidal shape.

### BACKGROUND AND SUMMARY OF THE INVENTION

Exemplary embodiments of the invention relate to a turbine wheel for a radial turbine.

Rotating components are caused to vibrate by rotation. This can take place by interaction with the non-rotating surroundings or, for example, due to the imbalance of the rotating component. The aim of the design is to ensure that no excitation frequency coincides with a natural frequency of the rotor, since this inevitably leads to vibration failure. When designing radial turbines, the design of the geometry with regard to the resulting natural frequencies of the blading is one of the key components in order to ensure mechanical strength. The problem is that, until now, increasing the natural frequency was only possible by shortening and thickening the blade.

DE 10 2006 008 836 A1 describes a method for producing and/or repairing an integrally bladed rotor. The method comprises the following steps:
a) Providing a rotor base, wherein the rotor base has at least one dome-shaped protrusion for connecting each rotor blade to the rotor base;
b) Providing at least one rotor blade, wherein the one or more rotor blades have corresponding dome-shaped protrusions for connecting to a dome-shaped protrusion of the rotor base;
c) Connecting the one or more rotor blades to the rotor base by inductive HF pressure welding, wherein the flattened dome-shaped protrusions of the one or more rotor blades are connected to the flattened dome-shaped protrusions of the rotor base;
d) Precisely processing one or more rotor blades that are connected to the rotor base.

Exemplary embodiments of the invention are directed to a novel turbine wheel for a radial turbine.

A turbine wheel for a radial turbine has a hub with a turbine disc connected thereto and a plurality of turbine blades that are connected to the hub via a blade foot, wherein the turbine blades each have a curvature that follows a line of curvature, wherein, when viewed from an orthogonal cut through the turbine blade, each turbine blade has a distribution of a thickness depending on a height of the turbine blade above the hub. According to the invention, the thickness of the turbine blade is greater at small heights than in a trapezoidal shape, in which the thickness decreases uniformly starting from the blade foot, and the thickness of the turbine blade is smaller at large heights of the turbine blade than in a trapezoidal shape.

By means of the present invention, a degree of freedom is created enabling an increase in blade natural frequencies without significantly increasing the blade thickness. By means of the invention, a slimmer design of blading of radial turbines is possible, thereby achieving efficiency advantages of the turbine.

The solution according to the invention is suitable, for example, for use in a motor vehicle, in particular a commercial vehicle, bus or passenger vehicle.

Exemplary embodiments of the invention are explained in more detail below by means of drawings.

### BRIEF DESCRIPTION OF THE DRAWING FIGURES

Here are shown:

FIG. 1 a schematic view of a turbine wheel of a radial turbine with a plurality of turbine blades

FIG. 2 a schematic view of the turbine wheel that is cut orthogonally to a line of curvature of one of the turbine blades, resulting in a sectional plane,

FIG. 3 a schematic top view of the sectional plane from FIG. 2,

FIG. 4 a detailed schematic top view of the sectional plane,

FIG. 5 a schematic diagram of a height depending on a thickness of the turbine blade according to the prior art, and

FIG. 6 a schematic diagram of a height depending on a thickness of the turbine blade for illustrating a distribution according to the invention of the thickness of the turbine blade.

Parts corresponding to one another are provided with the same reference numerals in all figures.

### DETAILED DESCRIPTION

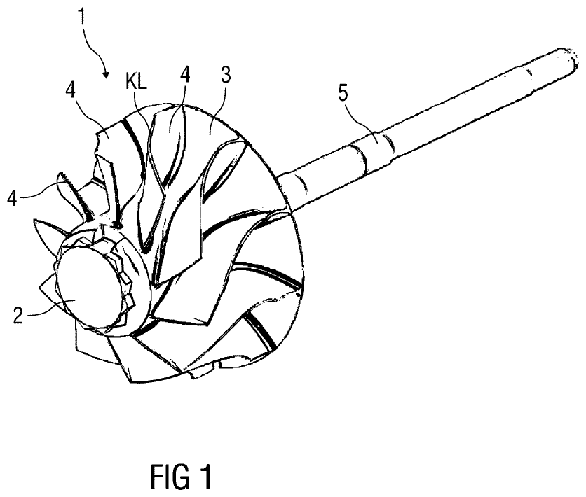

FIG. 1 is a schematic view of a turbine wheel 1 of a radial turbine, for example for an exhaust gas turbocharger. The turbine wheel 1 has a hub 2 with a turbine disc 3 connected thereto and a plurality of turbine blades 4. The turbine wheel 1 is arranged on a shaft 5. The turbine blades 4 are each curved. Here, the curvature of the turbine blades 4 follows a line of curvature KL.

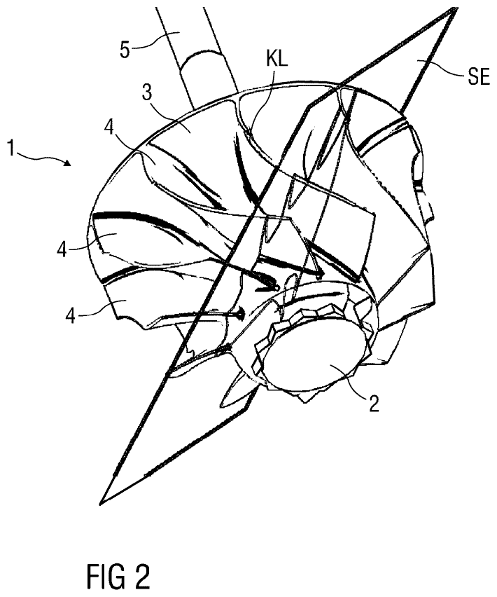

FIG. 2 is a schematic view of the turbine wheel 1, which is cut orthogonally to the line of curvature KL of one of the turbine blades 4, resulting in a sectional plane SE.

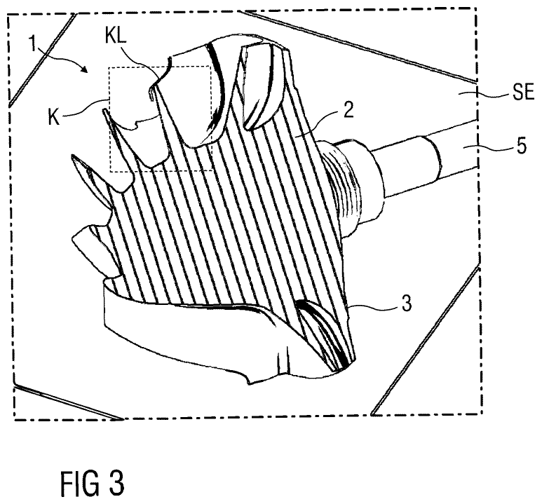

FIG. 3 is a schematic top view of the sectional plane SE from FIG. 2, which enables an observation of a distribution of a thickness of the turbine blades 4.

Here, the turbine blade 4, which is cut orthogonally in FIG. 2, is highlighted by a box K.

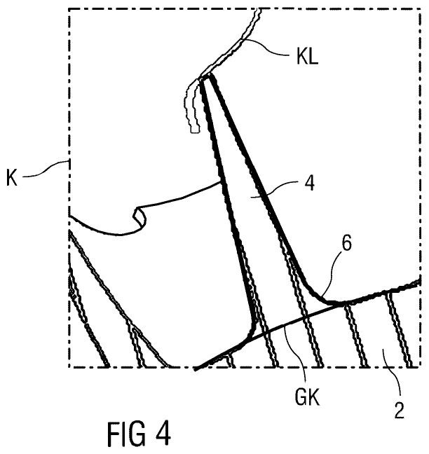

FIG. 4 is a detailed schematic top view of the sectional plane SE in the region of the box K. The turbine blade 4 sits on a contour of the hub 2 and has a rounded blade foot 6, via which it is attached to the hub 2.

FIG. 5 is a schematic diagram of a height Sh of the turbine blade 4 depending on a thickness Sd of the turbine blade 4 according to the prior art to illustrate the distribution of the thickness Sd of the turbine blade 4, wherein the basic shape of the distribution of the thickness Sd of the turbine blades 4 corresponds to a trapezoid.

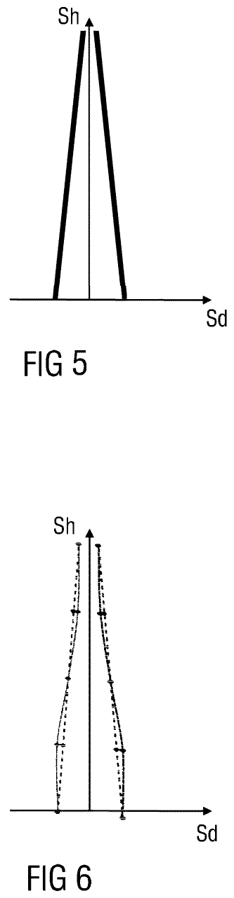

FIG. 6 is a schematic diagram of a height Sh of the turbine blade 4 depending on a thickness Sd of the turbine blade 4 to illustrate a distribution according to the invention of the thickness Sd of the turbine blade 4. It can be seen that the thickness Sd of the turbine blade 4 is greater at small heights Sh of the turbine blade 4 than in the trapezoidal shape of FIG. 5, and the thickness Sd of the turbine blade 4 is smaller at large heights Sh of the turbine blade 4 than in the trapezoidal shape of FIG. 5.

In particular, the thickness Sd of the turbine blade 4 can be distributed in such a way that, for heights Sh of from 0 to 66% of the maximum of the height Sh, the thickness Sd is greater than in the trapezoidal shape of FIG. 5, which is defined by the thickness Sd at Sh=0 and Sh=max. Alternatively or additionally, the thickness Sd for heights Sh from 33% of the maximum of the height Sh to the maximum of the height Sh can be smaller than in the trapezoidal shape of FIG. 5, which is defined by the thickness Sd at Sh=0 and Sh=max.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

1 Turbine wheel
2 Hub
3 Turbine disc
4 Turbine blade
5 Shaft
6 Blade foot
GK Basic circle
K Box
KL Line of curvature
Sd Thickness
SE Sectional plane
Sh Height

1-3. (canceled)

4. A turbine wheel for a radial turbine, the turbine wheel comprising:
a hub;
a turbine disc connected to the hub; and
a plurality of turbine blades connected to the hub via a respective plurality of blade feet,
wherein each of the turbine blades have a curvature following a line of curvature,
wherein, when viewed from an orthogonal cut through each of the turbine blades
each of the turbine blades has a distribution of a thickness depending on a height of the respective turbine blade above the hub,
each turbine blade has a trapezoidal shape portion,
the thickness of each of the turbines blades is greater at small heights above the hub of the respective turbine blade than in the trapezoidal shape portion,
the thickness of each of the turbine blades decreases uniformly starting from the respective blade foot, and
the thickness of each of the turbine blades is smaller at large heights above the hub of the respective turbine blade than in the trapezoidal shape portion.

5. The turbine wheel of claim 4, wherein the thickness of each of the turbine blades is distributed in such a way that, for heights from 0 to 66% of a maximum of the height, the thickness is greater than in the trapezoidal shape portion.

6. The turbine wheel of claim 4, wherein the thickness of each of the turbine blades for heights of 33% of the maximum of the height up to a maximum of the height is smaller than in the trapezoidal shape portion.
